(19) United States
(12) Patent Application Publication
(10) Pub. No.: US 2008/0283358 A1
(43) Pub. Date: Nov. 20, 2008

(54) Apparatus for Longitudinally Aligning Concrete Blocks on a Conveyor

(75) Inventor: Eric Milot, Montreal (CA)

Correspondence Address: WELLS ST. JOHN P.S., 601 W. FIRST AVENUE, SUITE 1300, SPOKANE, WA, 99201, US

(73) Assignee: D.I.T. EQUIPEMENTS INC.

(21) Appl. No.: 10/586,944

(22) PCT Filed: Jan. 24, 2005
(86) PCT No.: PCT/CA2005/000092

§ 371 Date: May 1, 2007

(30) Foreign Application Priority Data
Jan. 23, 2004 (CA) 2,455,798

(51) Int. Cl. B65G 47/24

(52) U.S. Cl. 198/392; 221/1

(57) ABSTRACT

An apparatus provided for orienting concrete blocks into a desired position comprises a pair of upper and lower turntables including respectively upper and lower block supporting surfaces. The lower supporting surface extends outwardly of, and below, the upper supporting surface. A stationary peripheral wall extends outwardly of the lower turntable and defines with the upper turntable and the lower supporting surface a gutter. The gutter is dimensioned to receive blocks therein in a substantially longitudinal orientation thereof. An outlet is provided at a downstream end of the gutter for allowing the substantially oriented blocks to be discharged from the apparatus. Therefore, concrete blocks, or the like, fed to the apparatus are received by the upper turntable, are then positioned in the gutter under the rotation of the upper and lower turntables, which typically rotate at different speeds, and are then discharged from the apparatus via the outlet.

### FIELD OF THE INVENTION

The present invention relates to concrete blocks and, more particularly, to an apparatus for positioning concrete blocks on a conveyor.

### BACKGROUND OF THE INVENTION

Concrete blocks that need to be handled for various purposes are often delivered in bulk. If the blocks are simply dropped on a conveyor, it becomes very difficult to then handle these blocks via automated machines. It is therefore desirable to facilitate the handling of these blocks to position them, for instance on a conveyor, typically in spaced succession thereon so that there is an expectancy of position of the blocks, whereby each block can be then be handled in an organized manner, e.g. via timed machinery.

Rotating turntables that receive such concrete blocks in bulk are used for delivering the blocks tangentially on an output conveyor that then carries the blocks downstream for further handling thereof. The rotation of the turntable causes the blocks to be delivered tangentially onto the conveyor in a spaced manner.

### SUMMARY OF THE INVENTION

It is therefore an aim of the present invention to provide a novel apparatus for receiving concrete blocks in bulk and for delivering such blocks downstream of the apparatus in a more organized manner for subsequent handling thereof.

Therefore, in accordance with the present invention, there is provided an apparatus for orienting blocks into a desired position, comprising a pair of upper and lower turntables including respectively upper and lower block supporting surfaces, said lower supporting surface extending outwardly of, and below, said upper supporting surface, a peripheral wall outwardly spaced from said upper supporting surface, said upper turntable, said lower supporting surface and said peripheral wall defining a gutter dimensioned to receive blocks therein in a substantially longitudinal orientation thereof, an outlet provided at a downstream end of said gutter for allowing substantially oriented blocks to be discharged from said apparatus, whereby blocks fed to said apparatus are received by said upper turntable, are positioned by said apparatus in said gutter and are discharged from said apparatus via said outlet.

Also in accordance with the present invention, there is provided a method for orienting blocks into a desired position, comprising the steps of:

(a) providing a pair of upper and lower turntables including respectively upper and lower block supporting surfaces, said lower supporting surface extending outwardly of, and below, said upper supporting surface, said lower turntable being configured and sized so that blocks completely received thereon are in a substantially longitudinal orientation thereof;

(b) feeding blocks on said upper turntable with a rotation of said upper and lower turntables causing the blocks to take position on said lower supporting surface in said substantially longitudinal orientation; and

(c) discharging the blocks in said substantially longitudinal orientation from said lower turntable.

Further in accordance with the present invention, there is provided an apparatus for orienting objects into a desired position, comprising a pair of upper and lower turntables including respectively upper and lower block supporting surfaces, said lower supporting surface extending outwardly of, and below, said upper supporting surface, a peripheral wall outwardly spaced from said upper supporting surface, said upper turntable, said lower supporting surface and said peripheral wall defining a gutter dimensioned to receive objects therein in a substantially longitudinal orientation thereof, an outlet provided at a downstream end of said gutter for allowing substantially oriented objects to be discharged from said apparatus, whereby objects fed to said apparatus are received by said upper turntable, are positioned by said apparatus in said gutter and are discharged from said apparatus via said outlet.

Still further in accordance with the present invention, there is provided a method for orienting objects into a desired position, comprising the steps of:

(a) providing a pair of upper and lower turntables including respectively upper and lower block supporting surfaces, said lower supporting surface extending outwardly of, and below, said upper supporting surface, said lower turntable being configured and sized so that objects completely received thereon are in a substantially longitudinal orientation thereof;

(b) feeding objects on said upper turntable with a rotation of said upper and lower turntables causing the objects to take position on said lower supporting surface in said substantially longitudinal orientation; and

(c) discharging the objects in said substantially longitudinal orientation from said lower turntable.

### BRIEF DESCRIPTION OF THE DRAWINGS

Having thus generally described the nature of the invention, reference will now be made to the accompanying drawings, showing by way of illustration a preferred embodiment thereof, and in which:

FIG. 1 is a top plan view of an apparatus in accordance with a first embodiment of the present invention, for longitudinally aligning concrete blocks on a conveyor, wherein there are also shown an input tumbler and output conveyor as well as concrete blocks;

FIG. 1A is a perspective view of an apparatus, which is similar to that of FIG. 1, in accordance with a second embodiment of the present invention, for longitudinally aligning concrete blocks on a conveyor, wherein there is also shown the input tumbler;

FIG. 2 is a top plan view, with details, of the apparatus of FIG. 1;

FIG. 3 is a vertical cross-sectional view of the apparatus taken along line 3-3 of FIG. 2;

FIG. 4 is an enlarged view of a central portion of FIG. 3;

FIG. 5 is an enlarged view of a right-side portion of FIG. 3;

FIG. 6 is a top plan view of part of the apparatus of FIG. 1, showing a sequential displacement of a concrete block up to a desired position thereof on the apparatus;

FIG. 7 is a perspective view of an apparatus in accordance with a third embodiment of the present invention, for longitudinally aligning concrete blocks on a conveyor, wherein there is also shown the input tumbler; and

FIG. 8 is a perspective view of an apparatus in accordance with a fourth embodiment of the present invention, for longitudinally aligning concrete blocks on a conveyor, wherein there is also shown the input tumbler.

### DESCRIPTION OF THE PREFERRED EMBODIMENTS

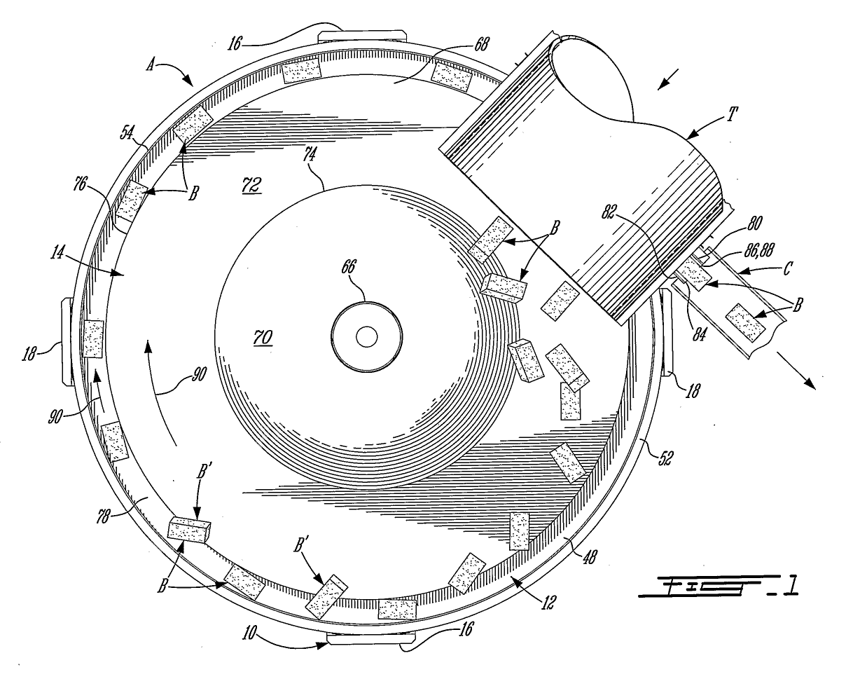

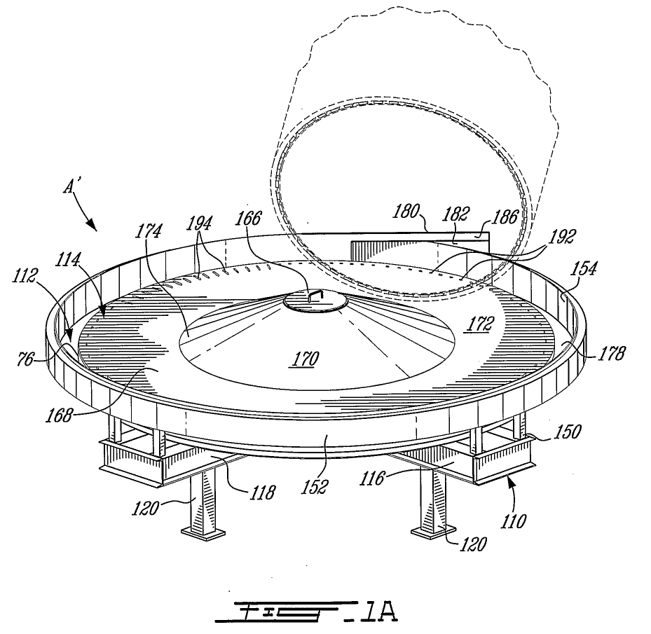

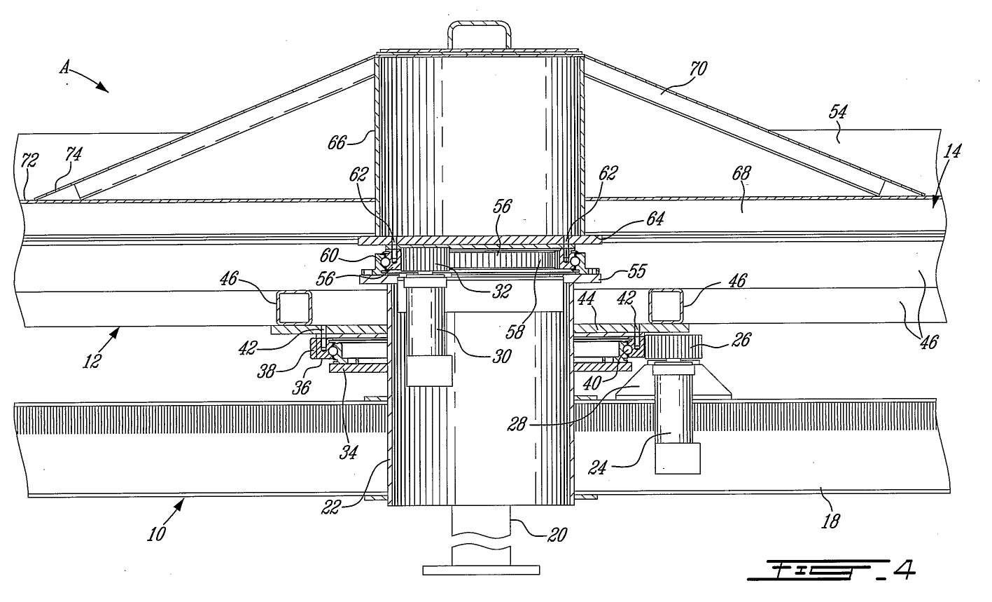

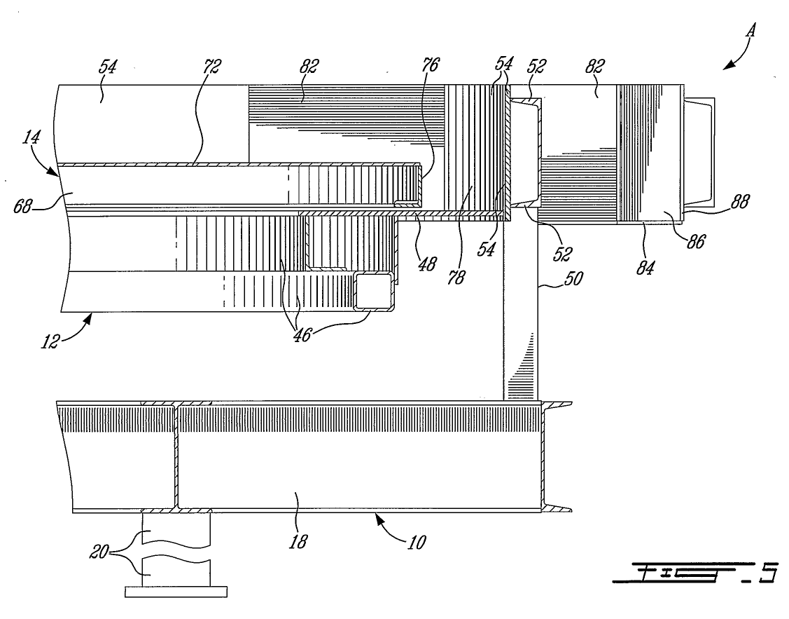

FIGS. 1 to 3 illustrate a concrete block handling apparatus A adapted for to longitudinally align concrete blocks B on an output conveyor C, the concrete blocks B being fed in bulk to the apparatus A via an input tumbler T. By having the concrete blocks B longitudinally aligned on the conveyor C, it becomes easier to further handle, e.g. in an at least partly automated process, the concrete blocks B in one or more subsequent stations located downstream of the conveyor C. FIGS. 4 and 5 are enlarged views that show more clearly some details of the apparatus A.

The apparatus A comprises a fixed base 10, a lower turntable 12 and an upper turntable 14. The fixed base 10 includes a pair of perpendicularly crossing horizontal support beams 16 and 18 that are mounted at upper ends of four (4) vertical posts. Centrally, a cylindrical support member 22 extends from the horizontal support beams 16 and 18. A first motor 24, provided with a first pinion 26 on its output shaft, is mounted to the horizontal support beam 18 via a bracket 28. The first motor 24, as will be described hereinafter, is adapted to rotatably drive the lower turntable 12.

A second motor 30, provided with a second pinion 32 on its output shaft, is mounted inwardly of the cylindrical support member 22. The second motor 32, also as will be described hereinafter, is adapted to rotatably drive the upper turntable 14.

A lower annular flange 34 is fixedly mounted horizontally around the cylindrical support member 22. A first toothed wheel 36, having teeth 38 on an outer periphery thereof, is rotatably mounted about the cylindrical support member 22 via a first ball bearing 40, an inner section of the first ball bearing 40 being fixedly mounted to the lower flange 34, whereas an outer section of the first ball bearing 40 is connected to the first toothed wheel 36. As the teeth 38 of the first toothed wheel 36 are in meshed engagement with the first pinion 26, actuation of the first motor 24 will cause the first pinion 26 to rotate thereby rotating the first toothed wheel 36.

The first toothed wheel 36 is connected to a superposed lower annular plate 44 of the lower turntable 12 via pins 42 such as to impart rotation thereto when the first motor 24 is operating. The lower turntable 12 also includes a number of structural members 46 and a support table 48, the structural members 46 fixedly joining the annular plate 44 to the support table 48. The support table 48 is adapted to receive thereon and to convey, in view of its rotation, the concrete blocks B to the output conveyor C, as will be described hereinafter.

The fixed base 10 comprises secondary posts 50 that extend vertically upwardly from the horizontal support beams 16 and 18. A C-channel 52 mounted atop the secondary posts 50 extends substantially completely around the lower turntable 12 and slightly outwardly thereof. A vertical wall 54 is mounted on an inner side of the C-channel 52, just exteriorly of an outer edge of the support table 48.

An upper annular flange 55 is fixedly mounted horizontally on top of the cylindrical support member 22. A second toothed wheel 56, having teeth 58 on an inner surface thereof, is rotatably mounted above the cylindrical support member 22 via a second ball bearing 60, an outer section of the second ball bearing 60 being fixedly mounted to the upper flange 55, whereas an inner section of the second ball bearing 60 is connected to the second toothed wheel 56. As the teeth 58 of the second toothed wheel 56 are in meshed engagement with the second pinion 32, actuation of the second motor 30 will cause the second pinion 32 to rotate thereby rotating the second toothed wheel 56.

The second toothed wheel 56 is connected to a superposed lower circular plate 64 of the upper turntable 14 via pins 62 such as to impart rotation thereto when the second motor 30 is operating. The upper turntable 14 also includes an upstanding cylinder 66 extending upwardly from the circular plate 64 and an annular table 68 fixedly mounted around a lower end of the cylinder 66 and atop the edge of the circular plate 64.

A frusto-conical structure 70 is provided around the cylinder 66 and atop the annular table 68, with a support surface 72 of the table 68 extending outwardly from a lower end 74 of the frusto-conical structure 70 up to a vertical peripheral wall 76 of the annular table 68. The support surface 72 is adapted to receive thereon and to convey, in view of its rotation, the concrete blocks B to the support table 48 of the lower turntable 12, which itself, as previously mentioned, carries the concrete blocks B to the output conveyor C.

The vertical wall 76 of the annular table 68 of the upper turntable 14, the support table 48 of the lower turntable 12 and the stationary vertical wall 54 define a channel-shaped gutter 78 adapted to receive the concrete blocks B therein, from the upper turntable 14, in such a way that the concrete blocks B are oriented longitudinally therein to allow the lower turntable 12 to convey the concrete blocks B onto the output conveyor C. The width of the gutter 78 is less than the length of the concrete blocks B and is slightly larger than the width thereof such that the concrete blocks B can only be received on the lower turntable 12 if they are in their longitudinal orientation. The height of the vertical wall 76 of the annular table 68 can be of approximately 1 inch (2.54 cm).

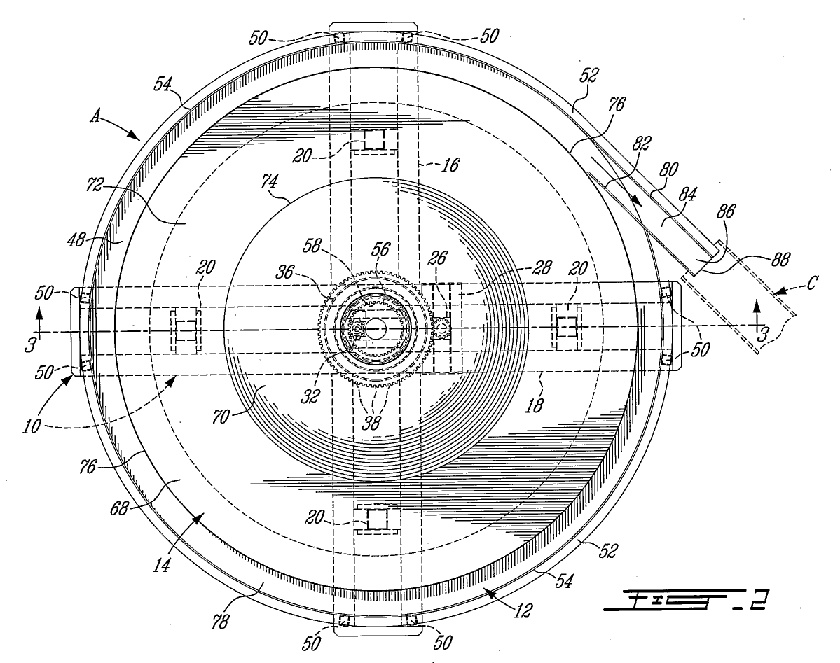

As best seen in FIGS. 2 and 5, the gutter 78 extends substantially all around the apparatus A, except at the level of the vertical wall 54 which includes, opposite the output conveyor C, a straight section 80 that extends tangentially to the outside edge of the support table 48 and, in fact, also to a curved remainder of the vertical wall 54. A stationary vertical guide plate 82 extends parallelly to the straight section 80 of the vertical wall 54 and tangentially to the vertical wall 76 of the annular table 68 of the upper turntable 14. Outwardly of the support table 48 of the lower turntable 12, there is provide a horizontal bottom wall 84 that connects together lower edges of the straight section 80 of the vertical wall 54 and of the guide plate 82. The straight section 80 of the vertical wall 54, the bottom wall 84 and the guide plate 82 form a straight discharge channel 86 that has a free downstream end 88 that overhangs an upstream end of the output conveyor C.

This arrangement causes the straight section 80 of the vertical wall 54 and the guide plate 82 to direct the concrete blocks B located on the support table 48 of the lower turntable 12 onto the discharge channel 86, which in turn conveys these concrete blocks B onto the output conveyor C.

The speed of the first and second motors 24 and 30 and/or the gear ratios between the first and second pinions 26 and 32 and the first and second toothed wheels 36 and 56, respectively, is such that lower and upper turntables 12 and 14 rotate at different speeds, for reasons which will become clear hereinbelow. For instance, the apparatus A can be set up so that the lower and upper turntables 12 and 14 rotate at 15 and 23 RPM, respectively.

Mainly referring now to FIG. 1, the operation of the apparatus A is as follows. The tumbler T drops concrete blocks B onto the upper turntable 14 and typically onto the frusto-conical structure 70 thereof. Both the lower and upper turntables 12 and 14 rotate in a same direction (see arrows 90), but generally at different speeds, as mentioned hereinabove. The general shape of the frusto-conical structure 70, including its slope, are such that the concrete blocks are directed onto the support surface 72 of the annular table 68 of the upper turntable 14, at which point the centrifugal force exerted by the support surface 72 on the concrete blocks B positioned thereon is sufficient to force the concrete blocks B outwardly towards and onto the support table 48 of the lower turntable 12, i.e. in the gutter 78.

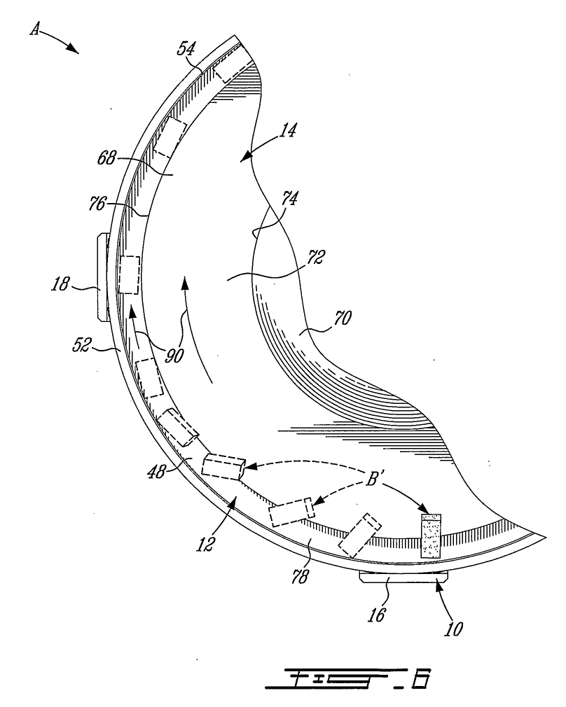

If a concrete block (see block B′ in FIGS. 1 and 6) becomes partly engaged in the gutter 78, the difference in speeds between the lower and upper turntables 12 and 14 will cause this concrete block B′ to gradually deflect until its longitudinal orientation is sufficiently close to a tangential direction of the lower turntable 12 that it will completely position itself, or drop, into the gutter 78, whereby the concrete block B′ is longitudinally positioned in the gutter 78. FIG. 6 illustrates consecutive positions of such a concrete block B′ from a substantially transversal position thereof with part thereof in the gutter 78, up to the block B′ being longitudinally positioned in the gutter 78.

As previously mentioned, the concrete blocks B are then guidingly removed from the gutter 78 and lower turntable 12 by the straight section 80 of the vertical wall 54 and by the guide plate 82, which direct the concrete blocks B onto the discharge channel 86, which in turn carries these concrete blocks B onto the output conveyor C, whereby the concrete blocks are longitudinally aligned on the output conveyor C. This facilitates, e.g. via an automated process, the handling of the blocks B in one or more downstream stations, for instance in a palletising station that automatically loads the concrete blocks B on a pallet.

Now referring to FIG. 1A, there is shown a variant concrete block handling apparatus A′, which is similar to the apparatus A of FIG. 1, whereby in the following description and drawings that pertain thereto, components which are identical in function and identical or similar in structure to corresponding components of the apparatus A of FIG. 1 (and FIGS. 2 to 6) bear the same reference as in FIG. 1 (and FIGS. 2 to 6) but are tagged with the suffix “1” and are thus in the hundreds with the last two digits thereof being identical to the reference numerals of corresponding components of apparatus A. New components (or components not identified for apparatus A) provided in apparatus A′ start at reference numeral 192.

Therefore, apparatus A′ of FIG. 1A is similar to apparatus A of FIG. 1 except that the support surface 172 of the annular table 168 of the upper turntable 114 further includes a series of bosses 192 and/or radially oriented fins 194. These bosses 192 and fins 194 provide frictional areas that may assist in displacing the concrete blocks B positioned more or less sideways (as concrete block B′ in FIGS. 1 and 6) to the desired positioned thereof, i.e. where the longitudinal orientation of the blocks B is substantially parallel to a tangent of the vertical wall 176, thereby allowing the blocks B to become completely lodged in the gutter 178. The bosses 192 are of approximately ⅛ inch in height and are provided at, or slightly inwardly of, the vertical wall 176. The bosses 192 are distributed along the periphery of the support surface 172 at intervals of, for instance, 8 to 12 inches, and typically 8 inches. Such bosses 192 may be formed by spot welding (hard facing).

As to the radially oriented fins 194, they are also provided at, or slightly inwardly of, the vertical wall 176 and are distributed along the periphery of the support surface 172 at pre-determined intervals. The length of the fins 194 may be a function of the maximal length of the products, e.g. concrete blocks, to be sorted (aligned). FIG. 1A shows both these bosses 192 and fins 194 for illustration purposes, as typically the upper turntable 114 will only be provided with one type of these protrusions.

Instead of the bosses 192 and radially oriented fins 194, it is noted that other frictional elements can be contemplated, such small rubber patches (not shown) that could be embedded in the annular table 168 of the upper turntable 114 so as to be substantially flush with the support surface 172 thereof and being able to frictionally engage the blocks B to pivot the same into, or towards, the desired afore-described position.

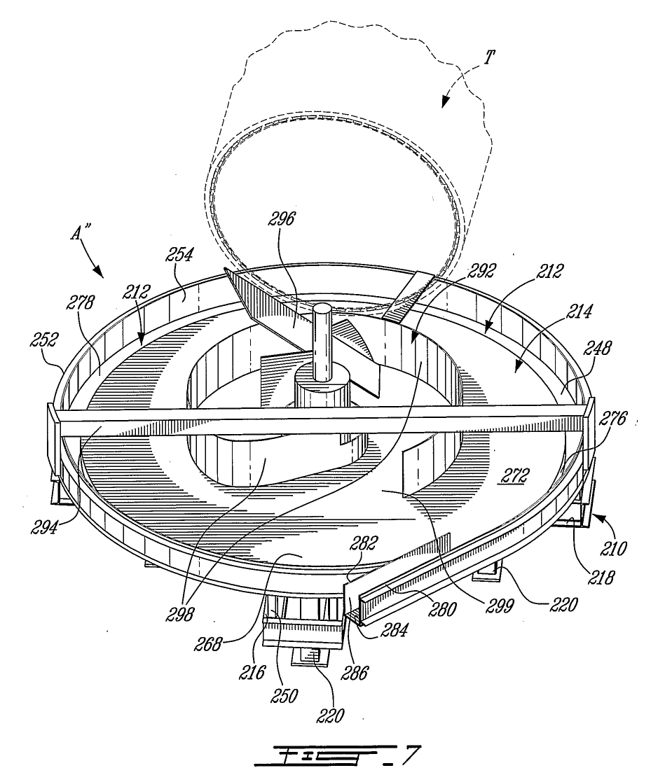

As seen in FIG. 7, there is shown a third concrete block handling apparatus A″, which is similar to the apparatus A of FIG. 1, whereby in the following description and drawings that pertain thereto, components which are identical in function and identical or similar in structure to corresponding components of the apparatus A of FIG. 1 (and FIGS. 2 to 6) bear the same reference as in FIG. 1 (and FIGS. 2 to 6) but are tagged with the suffix “2” and are thus in the hundreds with the last two digits thereof being identical to the reference numerals of corresponding components of apparatus A. New components (or components not identified for apparatus A) provided in apparatus A″ start at reference numeral 292.

In apparatus A″ of FIG. 7, there is further provided a volute or spiral-shaped guide 292 that is fixedly mounted above the upper turntable 214, e.g. via an overhead support beam 294. The guide 292 is shaped and configured to “pre-align” the concrete blocks B before they release onto the support surface 272 of the annular table 268 of the upper turntable 214. This can reduce the amount of displacement that is required to be induced by the annular table 268 of the upper turntable 214 to the concrete blocks B so that the concrete blocks B can lower in the desired position in the gutter 278, i.e. on the support table 248 of the lower turntable 212. The guide 292 basically includes a descent plate 296 and a spiral-shaped wall 298. The blocks B dropping from the input tumbler T are delivered by the descent plate 296 onto the support surface 272 of the annular table 268, and the vertical spiral wall 298 then guides the blocks B, as they are being displaced under the rotation of the annular table 268, towards the periphery of the annular table 268. The position of an exit 299 of the guide 292 with respect to the discharge channel 286 of the apparatus A″ forces the blocks to remain on the annular table 268 for at least one full rotation thereof. This arrangement provides for a longer pre-aligning of the blocks B before they reach the gutter 278.

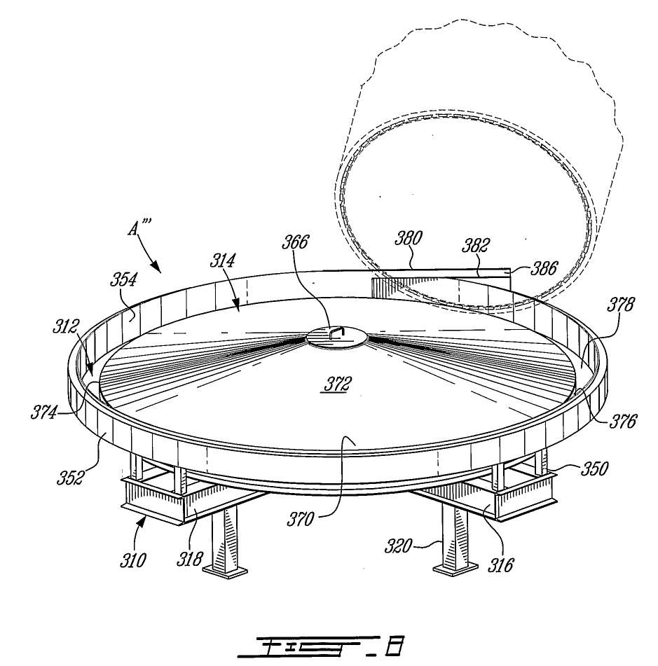

Now turning to FIG. 8, there is shown a fourth concrete block handling apparatus A′″, which is similar to the apparatus A of FIG. 1, whereby in the following description and drawings that pertain thereto, components which are identical in function and identical or similar in structure to corresponding components of the apparatus A of FIG. 1 (and FIGS. 2 to 6) bear the same reference as in FIG. 1 (and FIGS. 2 to 6) but are tagged with the suffix “3” and are thus in the hundreds with the last two digits thereof being identical to the reference numerals of corresponding components of apparatus A. New components (or components not identified for apparatus A) provided in apparatus A′″ start at reference numeral 392.

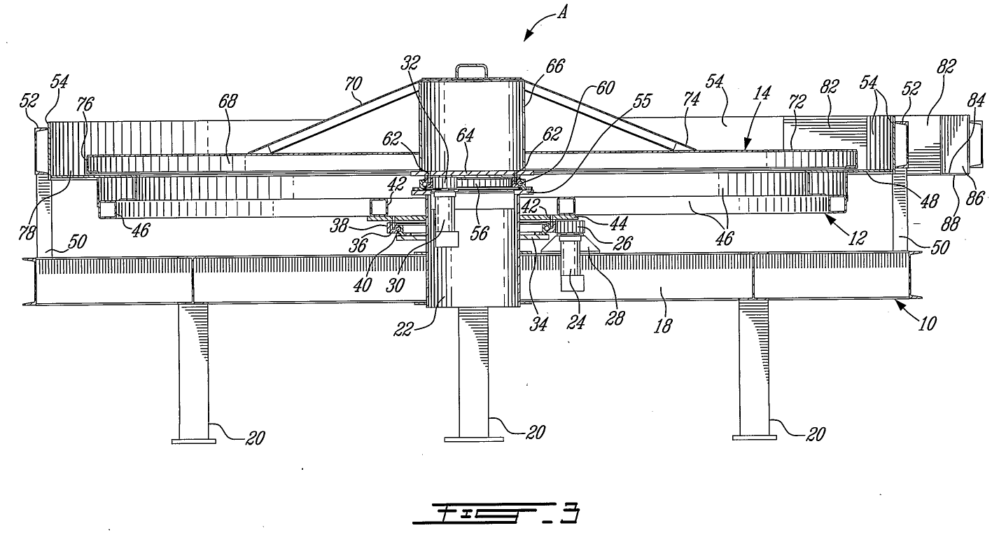

Therefore, in apparatus A′″ of FIG. 8, the frusto-conical structure 70 of FIG. 1 takes the form of frusto-conical structure 370 that extends to the peripheral edge of the annular table 368 of the upper turntable 314, i.e. to, or close to, the vertical peripheral wall 376. In such a case, the angle of the frusto-conical structure 370, with respect to the horizontal, could be less than that illustrated in FIG. 3. The frusto-conical structure 370 of apparatus A′″ can permit a reduced rotation speed of the upper turntable 314 as the force required to overcome friction forces between the concrete blocks B and the support surface 372 and so displace the concrete blocks B outwardly into the gutter 378 now includes, in view of the slope of the frusto-conical structure, a gravity force component that acts with the centrifugal force component on the concrete blocks B. Therefore, as the required centrifugal force component is less than if the support surface 372 is horizontal, the upper turntable 314 can be rotated at a lesser speed.

Although the present invention has been described hereinabove by way of specific embodiments thereof, it can be modified, without departing from the spirit and nature of the subject invention as defined in the appended claims.

What is claimed is:

1. An apparatus for orienting blocks into a desired position, comprising a pair of upper and lower turntables including respectively upper and lower block supporting surfaces, said lower supporting surface extending outwardly of, and below, said upper supporting surface, a peripheral wall outwardly spaced from said upper supporting surface, said upper turntable, said lower supporting surface and said peripheral wall defining a gutter dimensioned to receive blocks therein in a substantially longitudinal orientation thereof, an outlet provided at a downstream end of said gutter for allowing substantially oriented blocks to be discharged from said apparatus, whereby blocks fed to said apparatus are received by said upper turntable, are positioned by said apparatus in said gutter and are discharged from said apparatus via said outlet, wherein said upper and lower turntables rotate at different speeds and in a same direction.

2. An apparatus as defined in claim 1, wherein said upper turntable comprises a central sloped structure adapted for displacing the blocks received thereon towards said upper supporting surface.

3. An apparatus as defined in claim 2, wherein said sloped structure includes a section substantially shaped as at least part of a cone.

4. An apparatus as defined in claim 1, wherein said peripheral wall defines an outside limit of said gutter.

5. An apparatus as defined in claim 4, wherein said peripheral wall is stationary with said upper and lower turntables rotating inwardly thereof.

6. An apparatus as defined in claim 1, wherein said outlet includes a guide extending downstream of said gutter and adapted to receive blocks therefrom.

7. An apparatus as defined in claim 6, wherein said guide comprises a pair of substantially straight, substantially parallel, substantially vertical stationary walls, said guide constituting a substantially tangential continuation of said gutter at said downstream end thereof.

8. An apparatus as defined in claim 7, wherein an outside wall of said stationary walls of said guide is substantially a continuation of a downstream end of said peripheral wall.

9. An apparatus as defined in claim 1, wherein said upper supporting surface is sloped outwardly downwardly towards said gutter.

10. An apparatus as defined in claim 9, wherein said upper supporting surface includes a section substantially shaped as at least part of a cone, said section sloping towards said gutter.

11. An apparatus as defined in claim 1, wherein said upper supporting surface is provided with deflecting members adapted to cause the blocks to displace.

12. An apparatus as defined in claim 11, wherein said deflecting members are positioned close to a periphery of said upper supporting surface.

13. An apparatus as defined in claim 12, wherein said deflecting members comprise bosses that protrude upwardly from said upper supporting surface.

14. An apparatus as defined in claim 12, wherein said deflecting members comprise frictional elements that are substantially flush with said upper supporting surface.

15. An apparatus as defined in claim 12, wherein said deflecting members comprise fins extending substantially radially onto said upper supporting surface.

16. An apparatus as defined in claim 1, wherein a spiral-shaped guiding device is provided above said upper turntable for guiding the blocks fed to said apparatus onto and along said upper supporting surface towards a periphery of said upper supporting surface.

17. An apparatus as defined in claim 16, wherein said guiding device is stationary and is configured to gradually guide the blocks outwardly along said upper turntable.

18. A method for orienting blocks into a desired position, comprising the steps of:
(a) providing a pair of upper and lower turntables including respectively upper and lower block supporting surfaces, said upper and lower turntables rotating at different speeds and in a same direction, said lower supporting surface extending outwardly of, and below, said upper supporting surface, said lower turntable being configured and sized so that blocks completely received thereon are in a substantially longitudinal orientation thereof;
(b) feeding blocks on said upper turntable with a rotation of said upper and lower turntables causing the blocks to take position on said lower supporting surface in said substantially longitudinal orientation; and
(c) discharging the blocks in said substantially longitudinal orientation from said lower turntable.

19. An apparatus for orienting objects into a desired position, comprising a pair of upper and lower rotating supports including respectively upper and lower object supporting surfaces, said lower supporting surface extending outwardly of, and below, said upper supporting surface, a peripheral wall outwardly spaced from said upper supporting surface, said upper rotating support, said lower supporting surface and said peripheral wall defining a gutter dimensioned to receive objects therein in a substantially same orientation thereof, said gutter having an outlet for allowing substantially oriented objects to be discharged from said apparatus, whereby objects fed to said apparatus are received by said upper rotating support, are positioned by said apparatus in said gutter and are discharged from said apparatus via said outlet, wherein said upper and lower rotating supports rotate at different speeds and in a same direction.

20. A method for orienting objects into a desired position, comprising the steps of;
(a) providing a pair of upper and lower rotating supports including respectively upper and lower object supporting surfaces, said upper and lower rotating supports rotating at different speeds and in a same direction, said lower supporting surface extending outwardly of, and below, said upper supporting surface, said lower rotating support being configured and sized so that objects completely received thereon are in a substantially same orientation thereof;
(b) feeding objects on said upper rotating support with a rotation of said upper and lower rotating supports causing the objects to take position on said lower supporting surface in said substantially same orientation; and
(c) discharging the objects in said substantially same orientation from said lower rotating support.

21. A method as defined in claim 20, wherein said objects are elongated and wherein said same orientation is longitudinal.
